(19) United States
(12) Patent Application Publication
(10) Pub. No.: US 2008/0057184 A1
(43) Pub. Date: Mar. 6, 2008

(54) Residential Lawn Marking and Decorating System and Method

(75) Inventor: Paul Stein, Rocky River, OH (US)

Correspondence Address: PATENT, COPYRIGHT & TRADEMARK LAW GROUP, PO BOX 506, RICHFIELD, OH, 44286, US

(73) Assignee: Turf Tattooz, Inc.

(21) Appl. No.: 11/850,615

(22) Filed: Sep. 5, 2007

Related U.S. Application Data
(60) Provisional application No. 60/842,692, filed on Sep. 6, 2006.

(51) Int. Cl. B05B 15/04; E01C 5/00

(52) U.S. Cl. 427/136; 118/301

(57) ABSTRACT

A user places a vinyl stencil on the lawn, securing it with a set of U-shaped pins, nails or stones, bricks, weights or the like. The stencil has a plurality of holes and the user places white paint over the hole. The user then removes the stencil, which leaves their lawn with a white dotted pattern on their lawn. The user then paints the laws according to the pattern left by the stencil. The instant abstract is neither intended to define the invention disclosed in this specification nor intended to limit the scope of the invention in any way.

### RELATED APPLICATIONS

The present invention claims the benefit of U.S. Ser. No. 60/842692 filed on Sep. 6, 2006 and incorporated by reference as if fully rewritten herein.

### COPYRIGHT STATEMENT

Some of the material in this patent document is subject to copyright protection under the copyright laws of the United States and other countries. The copyright owner has no objection to the facsimile reproduction by anyone of the patent document or the patent disclosure, as it appears in office government records, but otherwise all other copyright rights whatsoever are reserved.

### BACKGROUND OF THE INVENTION

1. Field of the Invention

The present invention relates generally to turf and lawn aesthetics and, more particularly, to an improved residential lawn marking and decorating system and method.

2. Description of the Related Art

Outdoor athletic playing fields, such as playing fields used for football, baseball, soccer or the like, require periodic application of boundary or market lines in order to define the limits of the playing field and subareas thereof. Such lines are usually made by applying white chalk or a specially formulated marking paint to a selected area. In addition to providing these utilitarian markings to the playing field, it has become common to include additional aesthetic elements as well, such as the mascot, logo, or team name, in the same or similar manner. In addition to such team logos and the like, for athletic events having significant media exposure such a forum has also become a medium for marketing or advertising of companies, products, or services.

Such sporting events play an important role in American society. One of the aspects of sports that have taken root in America is a particular dedication of fans to a specific team. Many sports teams are well known for the intense following from their fan base. In addition to raising revenue, a quality sports team can produce a large amount of secondary benefits. A professional sports team can being instill a sense of community pride. A collegiate sports team with an established and traditional alumni base can bring in enormous fund-raising for the institution. A high school sports team can be influential in civic pride as well as the passing of a public bond issue for supporting the public schools. Even a unaffiliated team, such as Jeff Gordon's 24 DuPont Team, can provide a valuable sponsorship opportunity for a company such as DuPont.

The combination of the important benefits a sports team provides and the intensity some fans have for their teams creates an omnipresent market for novel and unique ways of fans showing their support. Currently there are products available ranging from team jerseys to foam fingers.

While currently being utilized only on an institutional level, there is no available product or method, absent individual artistic ability and resource, that allows a general consumer fan to transpose their favorite team logo onto their personal lawn. Additionally, there is currently no product to allow a fan to allow their yard to imitate the field of their favorite sports team.

Consequently, a need has been felt for providing an improved lawn decoration system.

### SUMMARY OF THE INVENTION

It is therefore an object of the present invention to provide an improved residential lawn marking and decorating system and method.

Briefly described according to the preferred embodiment of the present invention, improved residential lawn marking and decorating system and method is provided that utilizes a kit incorporating a single layer, large area stencil, securing pins or other means for positioning and holding the stencil, several cans of turf marking paint, as well as written instructions as to the method to be employed. An image, such as a team logo, is designed as a computer generated or “camera ready image”, and is converted to a series of guide points. The guide points are placed along transitions between line directions, transitions between colors, and the like, such as to form a connect-the-dot type template image. This template image is transferred to a large area sheet material through the use of a precision CNC knife cutting or cam cutting machine. While the use of precision laser cutting machines can also be used, it has been found that such lasers tend to melt conventionally available materials such as vinyl, polypropylene, and polyethylene sheets. Precision knife or cam cutting machines can be utilized effectively for such material, and it has been found that a sheeting material of approximately 4 mils (0.004 inches) in thickness is sufficient for the purposes anticipated herein. The sheeting material is formed as large as an eight foot by eight foot square, or within this envelope. Such a size is unique within the industry, in that most available “CAD Cutting” using knife cut technology, or even dynamic laser cutting applications (DLCA), each have an alignment/holding/cutting surface no greater than a six foot by six foot square.

By adapting this technology, the stencil itself can be formed in a larger area on which an image guide is created. Further, high cutting speeds, flexibility of shape and size, high quality and accuracy, and cost-effective cutting can be achieved, even with small lot sizes.

With the stencil formed in the form of a plurality of guide apertures aligned along image demarcation points, a user places and secures the vinyl stencil on the lawn, securing it with a set of U-shaped pins or other securing means. With the stencil in position, the user utilizes an upside down dispensable, aerosol based turf marking paint to mark the plurality of holes of the guide apertures. It is anticipated that a white would be used. The user then removes the stencil, which leaves their lawn with a white dotted pattern on their lawn. The user then paints the lines according to the pattern left by the stencil as directed by image production instructions.

It is anticipated that a number of different colors would be used to generate a lawn or turf decoration emulating a multi-colored logo or image similar to the original camera ready image.

An advantage of the present invention is that it allows a user to place an image their lawn that will eventually grow out.

Another advantage of the present invention is that it is a cost effective way for a user to show support for their favorite sports team.

Further, it has been found that applying white chalk or paint to a strip of grass is relatively ineffective in that the white chalk will filter down through the grass and the white paint will soon be lost through repeated growth and cutting of the grass, preventing any permanent marking of the turf or lawn.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a kit providing an improved residential lawn marking and decorating system;

FIG. 2 is a top view of the stencil in the improved lawn decoration system;

FIG. 3 is a flow chart describing the method for providing a logo or image indicia on a grassy surface;

FIG. 4. is an example of written instructions 18 for use therewith; and

FIG. 5. is a point of purchase display 30 providing for an alternate method of creating a kit for providing an improved residential lawn marking and decorating system.

### DESCRIPTION OF THE PREFERRED EMBODIMENTS

The best mode for carrying out the invention is presented in terms of its preferred embodiment, herein depicted within the FIGS.

### 1. Detailed Description of the Figures

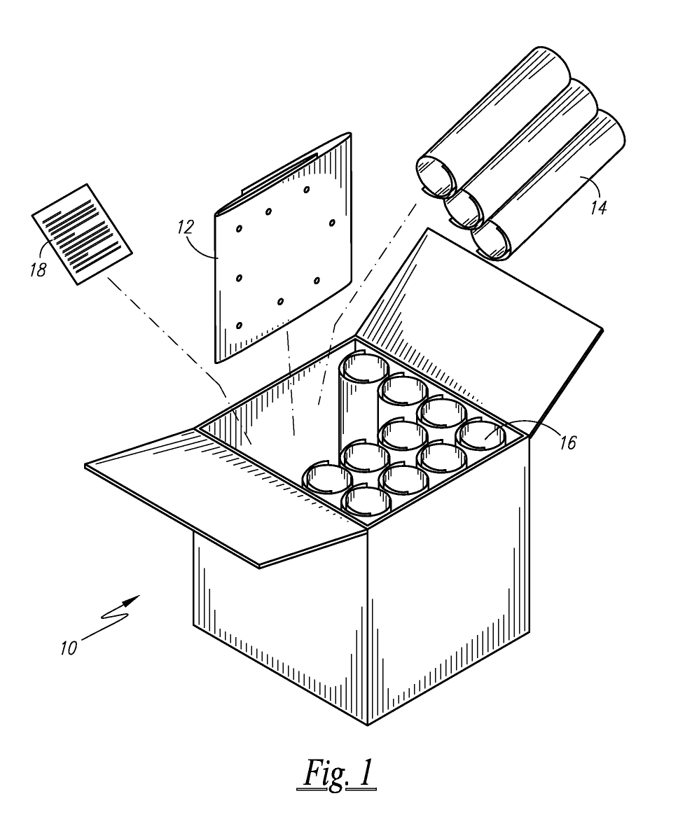

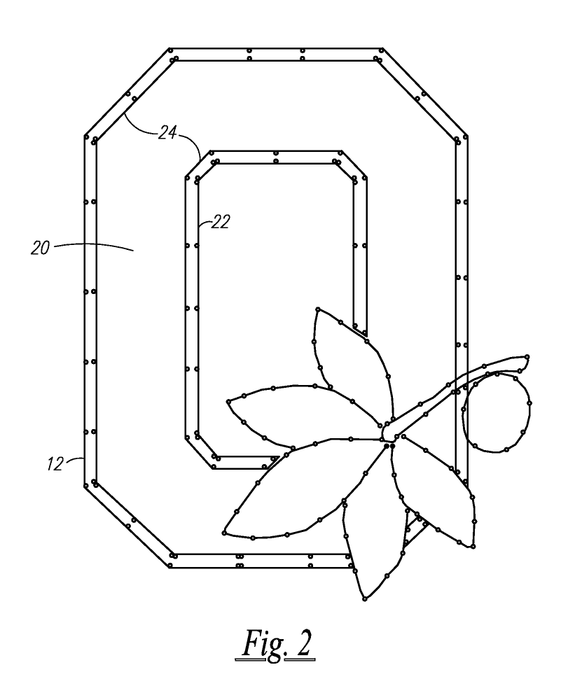

FIG. 1 discloses a residential lawn marking and decorating system 10 including forming a kit incorporating a single layer, large area stencil 12, several lining boards 15 having straight or curved edges (for lining over the dotted edges as will be described in greater detail below) several cans of turf marking media 16 such as paint, as well as written instructions 18 as to the method to be employed. A method for securing the stencil 12, such as securing pins 14 or other means such as nails, rocks, etc. are used for positioning and holding the stencil 12. As shown in conjunction with FIG. 2, the stencil 12 forms an image 20 formed in the form of a plurality of guide apertures 22 aligned along image demarcation points 24. While a sports field logo is preferred, it is possible to use any type of logo, such as a corporate name or trademarked image. Additionally, while sports logos are preferred any logo or picture type can be used. For instance, if a person has a strong loyalty to Chevrolet automobiles, the Chevrolet logo could be placed on the lawn. Furthermore, a user could take a photograph, have stencil made, and use the same system to place the picture on the lawn, such as a picture of a favorite grandchild.

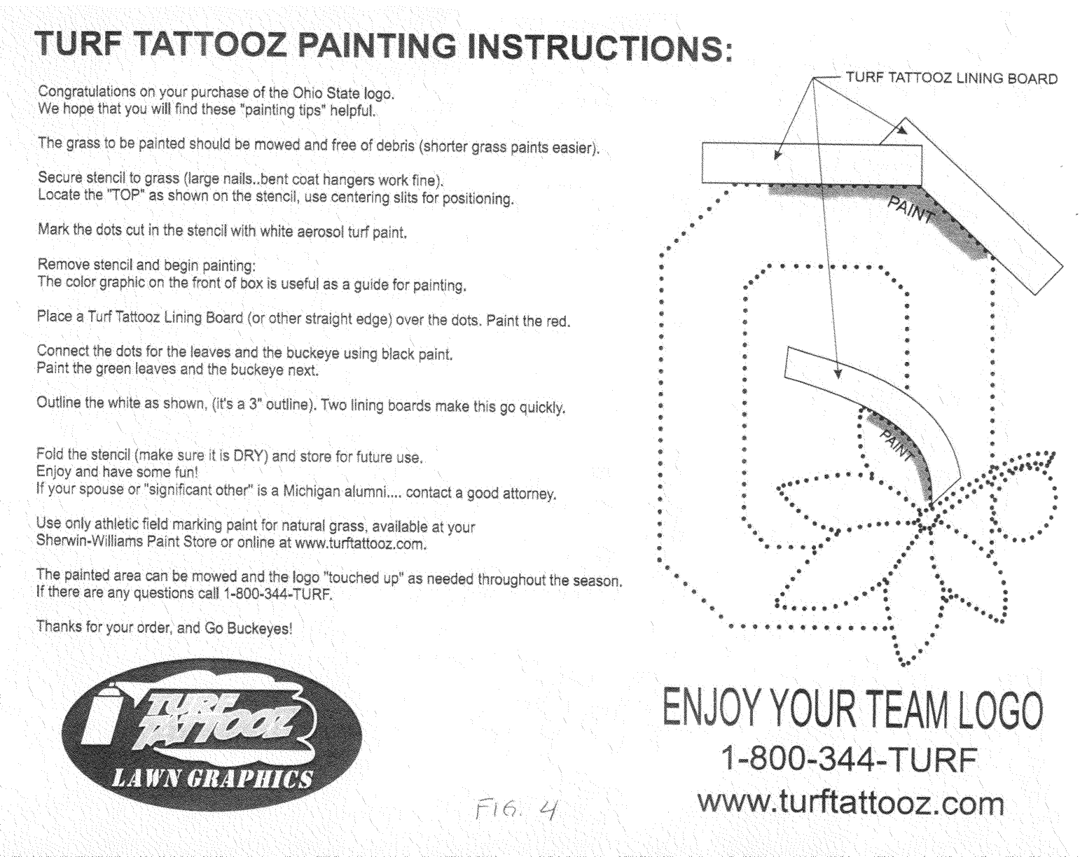

The securing pins 14 can be any means for positioning and holding the stencil 12 to the ground, and can even be replaced by stones, bricks, nails or the like. Further, it is envisioned that a number of different colors of marking media 16 can be employed, depending upon the overall surface area and colors of the finished image. As shown in conjunction with FIG. 4, one of several lining boards 15 is then used to form a demarcation line along a series of demarcation points 24. In this manner, an advantages is obtained by allowing common demarcation line shapes to be formed using a single, smaller lining board 15 that is easier manipulated than would a larger stencil encompassing the entire image to be formed.

### 2. Operation of the Preferred Embodiment

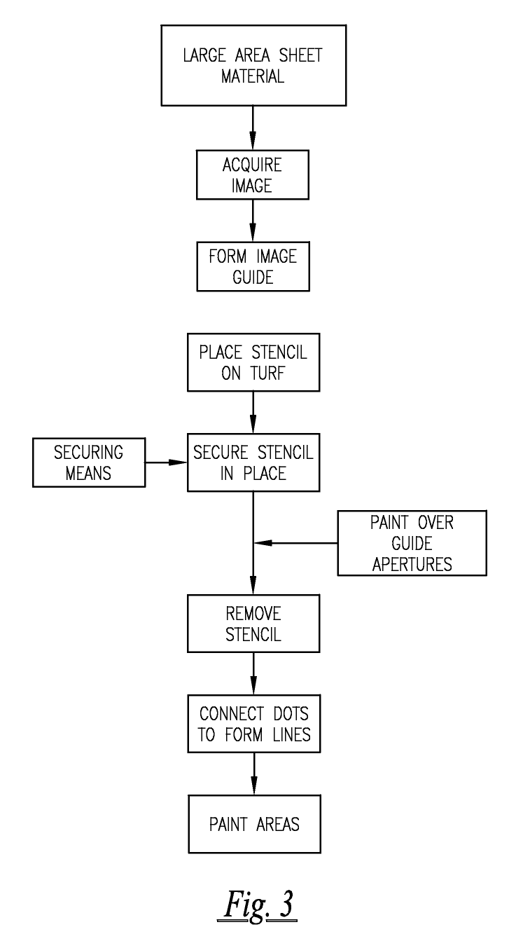

As described in FIG. 3 and 4, to use the present invention, a stencil is formed in the form of a plurality of guide apertures aligned along image demarcation points, a user places and secures the vinyl stencil on the lawn, securing it with a set of U-shaped pins or other positioning/securing means. With the stencil in position, the user utilizes an upside down dispensable, aerosol based turf marking paint to mark the plurality of holes of the guide apertures. It is anticipated that a white color would be used. The user then removes the stencil, which leaves their lawn with a white dotted pattern on their lawn. The user then paints the lawn according to the pattern left by the stencil as directed by image production instructions, utilizing the lining boards as a edge to span the required dotted pattern. The user then paints the logo based on the dots left from the application of white paint on the holes. The painting is done based on the paint scheme of the stencil. Preferably the paint used will come off easily, such as after a steady rain, but any type of paint, stain, or dye can be used provided it is not harmful or permanently damaging to the lawn.

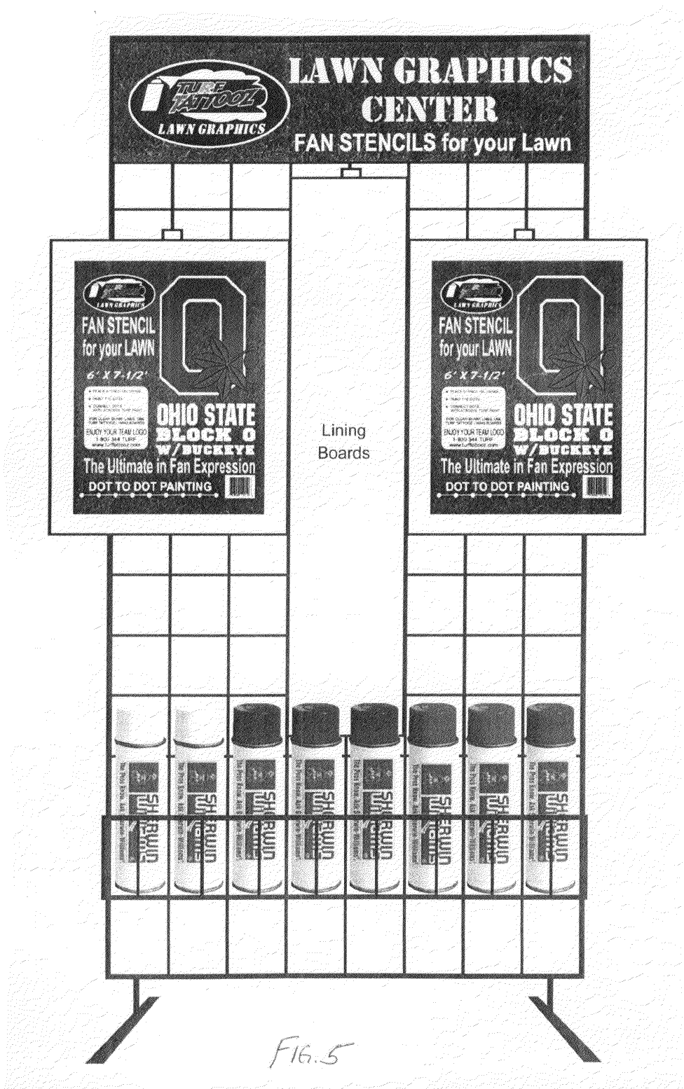

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. Alternate embodiments are therefore also envisioned. By way of example, and not as a limitation, FIG. 5 describes a point of purchase display 30 from which the user can create his or her own lawn stencil kit at the point of sale by purchasing the necessary stencils with directions, lining boards, and multiple colors of paint. As such, it is intended that the scope of the invention be defined by the Claims appended hereto and their equivalents. Therefore, the scope of the invention is to be limited only by the following claims.

Having thus described the invention what is claimed as new and desired to be secured by Letters Patent is as follows:

1. A residential lawn marking and decorating kit comprising:
a stencil, said stencil comprising a single layer, large area stencil forming an aperture at each of a series of guide points for forming a connect-the-dot type image;
at least one lining board for providing a demarcation edge spanning adjacent dots on said connect-the-dot type image; and
at least one can of turf marking paint.

2. The kit of claim 1, further comprising written instructions as to the method to be employed.

3. The kit of claim 1, wherein said stencil further comprises planar plastic sheet material of approximately an eight foot by eight foot square.

4. The kit of claim 1, further comprising securing means for positioning and holding the said stencil.

5. The kit of claim 4, wherein said securing means comprise u-shaped pins.

6. A method for decorating a turf surface comprising
a. Forming a stencil having a plurality of guide apertures formed therein, said guide apertures formed along image demarcation points;
b. Securing said stencil to a turf surface;
c. Marking over said guide apertures with a turf compatible marking media forming marked guide points;
d. Removing said stencil from said turf surface;
e. Connecting said marked guide points with said turf compatible marking media and forming an image outline;
thereby forming a decorative image on said turf surface.

7. The method of claim 5, further comprising the step of filling in of said image outline with said marking media.

8. The method of claim 5, wherein said marking media is selected from a group having more than one color.

9. The method of claim 5, wherein said stencil it approximately 8 foot by 8 foot.

10. The method of claim 5, wherein said stencil is formed by a method comprising:
a. Acquiring an image a computer generated digital format;
b. Converting said image to a series of guide points placed along transitions between line directions, transitions between colors, and the like, such as to form a connect-the-dot type template image;
c. Transferring said connect-the-dot type image to a large area sheet material through the use of a precision cutting machine;
d. Forming apertures at each said guide points for forming a connect-the-dot type image.
